(19) United States
(12) Patent Application Publication
(10) Pub. No.: US 2018/0016378 A1
(43) Pub. Date: Jan. 18, 2018

(54) LOW COLOR POLYURETHANE PREPOLYMERS FROM PARA-PHENYLENE DIISOCYANATE HAVING LOW FREE ISOCYANATE MONOMER CONTENT AND POLYURETHANES PREPARED THEREFROM

(71) Applicant: LANXESS SOLUTIONS US INC., Middlebury, CT (US)

(72) Inventors: Zhenya Zhu, New Milford, CT (US); George Brereton, Mahopac, NY (US)

(21) Appl. No.: 15/648,001

(22) Filed: Jul. 12, 2017

Related U.S. Application Data
(60) Provisional application No. 62/362,147, filed on Jul. 14, 2016.

(51) Int. Cl. C08G 18/10; C08G 18/76; C08G 18/48

(52) U.S. Cl. CPC C08G 18/10; C08G 18/4825; C08G 18/7614

(57) ABSTRACT

Co-distilling a mixture of para-phenylene diisocyanate (PPDI) and solvent, collecting the mixture of solvent and PPDI as a solution, reacting this solution with a polyol to form a prepolymer, and then removing unreacted PPDI by distillation in the presence of one or more solvents provides lower color prepolymer and higher quality polyurethane resin than a similar process that omits the co-distillation of PPDI and solvent prior to reaction with the polyol.

A process is provided for preparing prepolymers from para-phenylene diisocyanate (PPDI) and one or more polyols, which process comprises co-distilling a mixture of PPDI and one or more solvents, collecting the distillate to form a solution of PPDI in said solvent or solvents, mixing the PPDI solution thus obtained with one or more polyols under conditions to form the prepolymer, and then removing unreacted PPDI by co-distillation in the presence of one or more solvents, which process provides lower color prepolymers than a similar process that omits the co-distillation of PPDI and solvent prior to reaction with the polyol, and which prepolymers provide high quality polyurethanes upon cure.

### BACKGROUND OF THE INVENTION

Isocyanate-terminated prepolymers prepared from polyisocyanates and polyols, useful for the preparation of polyurethanes, are well known. In preparing polyurethane prepolymers, a polyol is reacted with an organic polyisocyanate monomer, e.g., a diisocyanate monomer, usually employing a stoichiometric excess of the polyisocyanate monomer, i.e., an NCO:OH ratio of greater than 1:1, often a large excess of the polyisocyanate monomer.

It is common to use large excesses of the monomeric polyisocyanates in order to minimize the formation of high molecular weight products and generate well defined prepolymer structures. For example, linear, isocyanate terminated prepolymers having a regular structure, such as a configuration ABA, ABABA, and the like, wherein A represents a group derived from a diisocyanate monomer and B represents a group derived from a diol, have been used in the preparation of elastomeric polyurethanes with excellent physical properties. However, the use a large excess of diisocyanate monomer results in an undesirable amount of unreacted diisocyanate monomer in the prepolymer reaction product mixture. US Pub Pat Appl 20030065124 discloses that improved handling and more controlled curing can be obtained using MDI prepolymers with reduced content of free MDI monomer in cast molding operations vs MDI prepolymers with standard, higher levels of free MDI monomer.

Various processes have been developed to reduce the quantity of unreacted monomeric diisocyanate levels in prepolymers including methods that use falling film evaporators, wiped film evaporators, other distillation techniques, solvent extraction, and molecular sieves. Of these processes, the use of evaporators and distillation is much simpler and more economical than solvent extraction or molecular sieve adsorption. However, in the distillation of diisocyanate monomers from polyurethane prepolymers, high temperatures must be avoided to prevent decomposition reactions in the prepolymer.

U.S. Pat. No. 4,182,825 discloses a process to reduce the amount of diisocyanate by distilling a prepolymer reaction product under vacuum conditions. U.S. Pat. No. 4,385,171 discloses a method for the removal of unreacted diisocyanate monomer from prepolymers by codistilling the prepolymer reaction product with a compound that boils at a temperature greater than the boiling point of the diisocyanate. U.S. Pat. No. 4,888,442 discloses a process for reducing the free monomer content of polyisocyanate adduct mixtures that comprises treating the polyisocyanate adduct mixture in the presence of 2 to about 30 percent by weight of an inert solvent, based on the weight of the polyisocyanate mixture, in an agitated thin-layer evaporator under conditions sufficient to reduce the free monomer content of the polyisocyanate adduct mixture below that level which is obtainable in the absence of a solvent.

The distillation processes described above relate mainly to removal of low boiling point diisocyanates, e.g., U.S. Pat. No. 4,182,825 and U.S. Pat. No. 4,385,171 relate mainly to the removal of unreacted diisocyanatotoluene (TDI) and U.S. Pat. No. 4,888,442 is directed primarily to the removal of unreacted 1,6-diisocyanatohexane, isophorone diisocyanate, 1,4-diisocyanatotoluene or 2,6-diisocyanatotoluene, all of which have a boiling point of 255° C. or less.

As disclosed in US Pub Pat Appl 20030065124, diphenylmethane diisocyanate (MDI), is not easily removed from prepolymer product mixtures by distillation owing to its much higher boiling point, i.e. 314° C., and the thermal sensitivity of MDI-based prepolymers. The process disclosed therein removes excess MDI by subjecting the prepolymer product mixture to distillation under vacuum conditions in the presence of an inert solvent having a boiling point of from 10° C. to 100° C. below that of the diisocyanate at a vacuum of 10 torr. The boiling point of MDI at 10 torr is 215° C. and the inert solvents used with MDI had a boiling point at 10 torr in the range of from 115° C. to 214° C. degree, for example, dimethyl phthalate diethyl phthalate, diisobutyl adipate, and dibutyl phthalate. The inert solvent of US Pub Pat Appl 20030065124 may be added after formation of the prepolymer, or MDI may be dissolved in the inert solvent, such as DMP or DBP, at a temperature of about 50° C. before charging the polyol.

U.S. Pat. No. 5,703,193 discloses a process that is particularly suited for the removal of para-phenylene diisocyanate (PPDI). PPDI has a relatively low molecular weight, 160, and a relatively high melting point, 95° C. and readily degrades to adducts of higher molecular weight if held at or above its melting point. For comparison, MDI has a melting point of 40° C., 1,4-diisocyanatotoluene has a melting point of 21° C., and 1,6-diisocyanatohexane has a melting point of −67° C. The high melting point of PPDI presents certain difficulties in the removal of unreacted monomer, because, as stated in US Pub Pat Appl 20030065124, in the operation of agitated film distillation equipment the condenser temperature for the distillate should be at least about 100° C. below the evaporative temperature to provide a driving force for rapid and efficient evaporation. High-melting distillates can be problematic because the condensation of the distillate must be carried out at a temperature where the distillate is still a liquid to prevent blocking of condensers. The atmospheric boiling point of PPDI is about 260° C. When PPDI prepolymers are distilled using film distillation equipment under standard conditions, the PPDI monomer frequently forms solid crystals on the cooler equipment surfaces, clogging the equipment and forcing termination of the distillation.

U.S. Pat. No. 5,703,193 describes a process for reducing the amount of residual polyisocyanate monomer, specifically PPDI monomer, in prepolymers by co-distilling the reaction product in the presence of a combination of two inert solvents, with the first inert solvent having a boiling point below the boiling point of the diisocyanate monomer and the second inert solvent having a boiling point above the boiling point of the diisocyanate monomer. As shown in the examples of U.S. Pat. No. 5,703,193, the use of only the first or only the second solvent allows for the removal of PPDI monomer, but clogging of the condenser with one of these solvents when used alone remains a problem. It is suggested that the higher-boiling inert solvent works in conjunction with the lower-boiling inert solvent to condense internally, keeping the internal condensing surfaces free of diisocyanate crystals.

Despite the process described in U.S. Pat. No. 5,703,193, improved methods for the removal of PPDI monomer from prepolymers and the preparation of low free PPDI monomer prepolymers are still needed. Surprisingly it has been found that first co-distilling a mixture of PPDI and a solvent and collecting the distillate as a solution of PPDI in the solvent, then using this PPDI solution in a reaction with a polyol to prepare a PPDI prepolymer, followed by co-distilling unreacted PPDI and solvent from the prepolymer product mixture, provides a PPDI prepolymer with a low level of free PPDI monomer that has excellent handling properties and lower color than a prepolymer prepared according to a similar process that excludes the first co-distillation, e.g., lower color than that obtained according to U.S. Pat. No. 5,703,193. A variety of solvents can be used in the process, and, as expected by one skilled in the art, inert solvents are typically preferred, that is, solvents that do not interfere with the formation of the prepolymer, e.g., solvents that do not react with PPDI, the polyol, the prepolymer, etc.

### SUMMARY OF THE INVENTION

The present invention provides a process for preparing prepolymers derived from PPDI and one or more polyols, also referred to herein as PPDI prepolymers, which process comprises:
i) co-distilling a mixture of PPDI and solvent and collecting the co-distillate as a solution of PPDI in said solvent,
ii) mixing the solution of PPDI obtained in i) with one or more polyols to prepare a prepolymer reaction mixture and reacting the prepolymer reaction mixture to form a prepolymer product mixture, and
iii) removing unreacted PPDI from the prepolymer product mixture by distillation of PPDI in the presence of one or more solvents to provide the prepolymer containing less than 1 wt %, e.g., less than 0.5 wt %, less than 0.1 wt %, or less than 0.05 wt %, free PPDI monomer, based on the total weight of the prepolymer.

The solvent of i) may comprise a single organic solvent or a mixture of more than one organic solvents. The terminology “one or more solvents” in iii) reflects the possible optional addition of another solvent or solvents before or during any of the processes in ii) and/or iii). As expected by one skilled in the art, best results are achieved using inert solvents.

PPDI has a boiling point of 260° C. at 760 torr and the distillations in i) and iii) are preferably conducted under reduced pressure. Solvents present during any of the distillations may have a bp that is higher or lower than that of PPDI, and as in U.S. Pat. No. 5,703,193, a mixture comprising an inert organic solvent having a bp above 260° C. at 760 torr and an inert organic solvent having a bp at or below 260° C. at 760 torr may be present. In many embodiments, the solvents present during the distillations comprise one or more inert organic solvents having a boiling point at 760 torr of less than 260° C., e.g., in some embodiments 90 or 95 to 100% by weight of the solvent is one or more inert organic solvents having a boiling point at 760 torr of less than 260° C.

In some embodiments of the invention, the solution or mixture of step i), or the prepolymer reaction mixture of step ii) comprises a small amount of one or more polyisocyanate monomers in addition to PPDI, e.g., in various embodiments PPDI is present, relative to all polyisocyanates present, in an amount of 80, 90, 95, 97 or 98 or 99 wt %, based on all polyisocyanate monomers present. Often, PPDI is the only polyisocyanate monomer used in the process.

For example, one embodiment of the invention provides a process for preparing a prepolymer from a mixture comprising PPDI and one or more polyols, which prepolymer comprises less than 1 wt %, typically less than 0.5 wt %, e.g., than 0.1 wt %, or less than 0.05 wt % free polyisocyanate monomer based on the total weight of the prepolymer, which process comprises:

i) subjecting a mixture comprising, based on the total weight of the mixture, from 5 to 85 wt % polyisocyanate monomer and from 15 to 95 wt % inert organic solvent, wherein 80 to 100% by weight of all polyisocyanate monomer present in the mixture is PPDI, to distillation under conditions wherein PPDI and the inert organic solvent co-distill, and collecting as distillate a solution comprising PPDI and the inert organic solvent;
ii) preparing a reaction mixture comprising the solution collected as distillate in i) with one or more polyols, which reaction mixture comprises a stoichiometric ratio of isocyanate groups to hydroxyl groups of from 1.1:1 to 15:1, under conditions wherein PPDI and the one or more polyol react forming a prepolymer product mixture comprising prepolymer, unreacted PPDI and inert organic solvent, and
iii) subjecting the prepolymer product mixture to distillation conditions to remove unreacted PPDI and inert organic solvent to yield a final prepolymer containing less than 1 wt %, typically less than 0.5 wt %, e.g., less than 0.1 wt %, or less than 0.05 wt % free polyisocyanate monomer.

In some embodiments, the mixture subjected to distillation in i) comprises, e.g., from 10 to 60 wt % polyisocyanate monomer and from, e.g., 40 to 90 wt % inert organic solvent. In some embodiments, the mixture subjected to distillation in i) comprises an inert organic solvent having a boiling point at 760 torr of less than 260° C., e.g., in some embodiments 90 to 100% by weight of inert organic solvent present in i) and/or iii) has a boiling point at 760 torr of less than 260° C.; and in some embodiments 95 to 100% by weight of the inert organic solvent is one or more inert organic solvents having a boiling point at 760 torr of less than 260° C., or the inert organic solvent consists essentially of one or more inert organic solvents having a boiling point at 760 torr of less than 260° C. “Consists essentially of” as used herein has the common meaning, i.e., that any other component present is present in too small an amount to change the overall properties of the element being described.

The invention also provides a low color prepolymer derived from PPDI and one or more polyols containing less than 1 wt %, e.g., less than 0.5 wt %, or less than 0.1 wt %, free PPDI monomer, based on the total weight of the prepolymer, prepared according to the present process, and a polyurethane composition prepared by reacting the low color prepolymer of the invention with one or more curing agents.

### DESCRIPTION OF THE INVENTION

The PPDI prepolymer prepared according to this invention is the reaction product of a polyol and a polyisocyanate wherein a majority, e.g., 80 wt % or more, often more than 90 or 95%, and in some embodiments all polyisocyanates, are PPDI, and is a “low free monomer prepolymer” meaning that it contains less than 1 wt %, e.g., less than 0.5 wt %, e.g., less than 0.1 wt % or less than 0.05 wt % free PPDI monomer. In selected embodiments, the PPDI prepolymer contains 0.1 wt % or less free PPDI monomer. The prepolymer has excellent chemical and physical properties, including very low color, and can be reacted with a curative to provide a polyurethane, e.g., a polyurethane elastomer, thermoplastic polymer, or thermoset polymer, with good physical properties.

The process of the invention for forming the low free PPDI prepolymer comprises a step wherein a mixture comprising PPDI and solvent is co-distilled to provide a solution comprising PPDI and the solvent, e.g., in some embodiments the solvent comprises at least one inert organic solvent having a lower boiling point than PPDI; a step wherein this solution is mixed with one or more polyols to form a reaction mixture in which the PPDI is reacted to form a prepolymer product mixture; and a step wherein unreacted PPDI and solvent, typically comprising the solvent employed in the co-distillation to prepare the PPDI solution and possibly other additional optional solvents, is co-distilled from the prepolymer product mixture to leave a PPDI prepolymer that contains less than 1 wt %, e.g., less than 0.5 wt %, e.g., less than 0.1 wt % or less than 0.05 wt % free PPDI monomer, based on the total weight of the prepolymer.

In embodiments where other polyisocyanates may be present during the reaction and in the prepolymer product mixture, the combined free polyisocyanate monomer present after step iii) is also less than 1 wt %, e.g., less than 0.5 wt %, e.g., less than 0.1 wt % or less than 0.05 wt %, based on the total weight of the prepolymer.

It is well understood in the art that a polyurethane prepolymer, such as the PPDI prepolymer of the invention, generally contains, in addition to any particular prepolymer compound, other compounds, typically in small amounts. Thus, there should be no confusion when a “prepolymer” is said to contain more than a single prepolymer molecule, such as other analogous prepolymers, unreacted starting materials, side products, solvents, etc.

As with many similar reactions, a stoichiometric excess of isocyanate monomer is present during the reaction to form the prepolymer, for example, a 1.1:1 to 15:1 excess of isocyanate monomer relative to polyol may be used, such as ratios ranging from 1.5 or 2:1 to 8:1, 10:1 or 12:1 isocyanate monomer to polyol. In particular embodiments, the ratio is at least 3:1, at least 4:1 or at least 5:1 of isocyanate monomer to polyol.

In the first step of the invention, a mixture comprising PPDI and solvent is co-distilled, and the distillate collected forms a PPDI solution in the solvent. This solution is then used in a reaction with one or more polyols to form a prepolymer. Although in some embodiments, other isocyanate monomers may be present in the mixture being distilled, or may be added to the solution obtained by the distillation or to the prepolymer reaction mixture, PPDI is a majority of all isocyanate monomers, typically at least 80 wt %, and often at least 80, 90, 95, 97 or 98 or 99 wt %, of all isocyanate monomers. In many embodiments, PPDI is the only isocyanate added to any mixture prepared in step i) or step ii).

The mixture of solvent and PPDI that is subjected to distillation in the first step of the invention is typically in the form of a solution and is prepared by mixing PPDI with one or more inert organic solvent typically selected from esters, diesters, lactones, carbonates, aromatic compounds, amides, lactams, polyethers, ketones and the like. In some embodiments, a solvent having a boiling point at 760 torr of less than 260° C. is present, for example, an inert organic solvent having a boiling point of from 100° C. to 259° C., e.g., a boiling point of from 120° C. to 259° C., more typically from 150° C., 1600° C. or 170° C. to 250° C., 255° C. or 259° C. In some embodiments, only solvents having a boiling point at 760 torr of less than 260° C. is present; in some embodiments, only solvents having a boiling point at 760 torr of greater than 260° C. is present; and in some embodiments, the solvent comprises a mixture of inert organic solvents wherein one or more has a boiling point at 760 torr of less than 260° C. and one or more has a boiling point at 760 torr of greater than 260° C. is present

The solvent used in the invention is an inert organic solvent, i.e., it does not react with the isocyanate monomer or the polyol under the conditions of the process. Suitable solvents include, e.g., 1,2,3-trichlorobenzene (bp 218° C.), 1,2,4-trichlorobenzene (bp 213° C.), o-dichlorobenzene (bp 180° C.), m-dichlorobenzene (bp 172° C.), p-dichlorobenzene (bp 173° C.), dimethylglutarate (bp 210-2150° C.), dimethyl adipate (bp 225-230° C.), diethyl adipate (bp 251° C.), dimethyl succinate (bp 200° C.), gamma-butyrolactone (bp 204-205° C.), delta-valerolactone (bp 208° C.), propylene carbonate (bp 240° C.) and N-methylpyrollidone (bp 204° C.), however, some solvents may not be stable under some conditions, e.g., some lactones may open and/or react with other components under some condition, and should be avoided when such conditions are used. In some embodiments for example, the inert organic solvent of the invention comprises 1,2,3-trichlorobenzene, 1,2,4-trichlorobenzene, o-dichlorobenzene, m-dichlorobenzene, p-dichlorobenzene, dimethylglutarate, dimethyl adipate, diethyl adipate, dimethyl succinate and/or N-methylpyrollidone, in some embodiments the inert organic solvent comprises dimethylglutarate, dimethyl adipate and/or diethyl adipate. In some embodiments, phthalate esters may be employed. In some embodiments, solvents boiling above 260° C., such as phthalates, are excluded.

Blends of solvents can be used in the process of this invention, provided they are miscible with the polyurethane prepolymer product mixture, and do not decompose or react with one another.

The mixture subjected to distillation in step i) comprises from 5 to 85 wt % polyisocyanate monomer and from 15 to 95 wt % inert organic solvent, e.g., from 5 to 50 wt %, and 10 to 40 wt %, from 5 or 10 to 60 wt % polyisocyanate monomer and from 40 to 90 or 95 wt % inert organic solvent, and in some embodiments the mixture may comprise from 15, 20 or 25 wt % to 35, 40 or 45 wt % polyisocyanate monomer and from 55, 60 or 65 wt % to 75, 80 or 85 wt % inert organic solvent. In general, the solution from the distillate of step i) will comprise polyisocyanate monomer and inert organic solvent in similar ranges.

In many embodiments, the only solvent present in steps ii) and iii) is the inert organic solvent introduced as part of the solution of polyisocyanate monomer, e.g., the inert organic solvent from the distillate collected in i), however, additional solvents may be added to the reaction mixture during step ii), or the prepolymer product mixture prior to or during the distillation of step iii). In some embodiments, solvents boiling above the boiling point of PPDI are not added, as such solvents will require more aggressive conditions, e.g., higher temperatures, to remove them from the product. For example, in some embodiments, any mixture of solvents present during steps i) and iii) does not comprise more than 10 wt %, e.g., does not comprise more than 5 wt %, of a solvent having a boiling point at 760 torr above 260° C.

In the second step of the process, the PPDI solution prepared via co-distillation in the first step is mixed with a polyol. The solvent of the first step is a reaction solvent in the second step. As suggested above, additional solvent may be added, often the same solvent.

Reactions of polyisocyanates and polyols are well known in the art, as are means for determining the relative amounts of isocyanate monomer and polyol. An excess of isocyanate monomer relative to polyol is used, and in some embodiments the ratio of isocyanate monomer to polyol is 2:1, 3:1, 4:1, 5:1 or higher, e.g., up to 8:1, 10:1 or 12:1. Catalysts or other components common in the art may also be added. Generally, heat is applied, for example, in some embodiments the reaction occurs at temperatures of from 35 to 150° C., and reaction temperatures of from 45 to 100° C. are typical. In some embodiments, the reaction temperature is kept at 95° C. or below.

After the reaction is complete, excess isocyanate is removed along with solvent using a distillation process. In general, the distillation processes of this invention are carried out in a conventional manner employed for purification by distillation. Use of distillation equipment, such as wiped film evaporation and vacuum distillation are familiar to those skilled in the art.

Any appropriate distillation method may be used in either of i) and iii), and in many embodiments the distillation in i) and/or iii) occurs under reduced pressure, e.g., from 0.01 to about 20 torr, in some embodiments from 0.02 to 10 torr, e.g., 0.05 or 0.1 to 2 torr. In some embodiments, the distillation of i) and/or iii) occurs by subjecting the material to more than one successive distillation step. Often, the distillation is conducted, at least in part, in agitated thin-film distillation equipment, also known as thin film evaporators, wiped film evaporators, short-path distillers, and the like, and two or more distillation units can, optionally, be used in series.

The actual temperature and pressure conditions of the distillation in step iii) should be such that the vaporization point of the diisocyanate monomer is exceeded without decomposing the polyurethane prepolymer. In one particular embodiment, at least a part of the distillation of step iii) is carried out using a wiped film evaporator at jacket temperatures ranging from about 90 or 100° C. to about 160 or 170° C., at a pressure ranging from about 0.01 to about 2 torr. For example, in one embodiment the unreacted polyisocyanate comprising unreacted PPDI and the inert organic solvent is co-distilled from the prepolymer using a wiped film evaporator with a jacket temperature of from 110 to 130° C., a temperature of from 20 to 35° C. for the internal condenser and a pressure of from 0.1 to 2 torr.

The one or more polyols used in the preparation of the present prepolymers may be selected from any polyol known in the art, for example, polyether polyols, polyester polyols, polycaprolactone polyols, polycarbonate polyols, co-polyester polyols, alkane polyols, or mixtures thereof. In many embodiments, the polyol will have a number average molecular weight from about 200, 250 or 400 to about 6000 or 10,000 Daltons, in some embodiments a lower molecular weight polyol may also be present. In many embodiments, diols are preferred over triols and polyols having a larger number of hydroxyl groups.

Despite “ester” being a general term often used to encompass acyclic and cyclic esters, and sometimes even “carbonates”, one skilled in the art recognizes that materials sold as polyester polyols, polycaprolactone polyols, and polycarbonate polyols have, and generally impart to the prepolymer and polyurethane, different characteristics, and are typically marketed as different materials. In the present application the terms “polyester polyol”, “polycaprolactone polyol”, and “polycarbonate polyol” are used to refer to three separate materials. “Polyester polyol” as used herein refers to a polyol having a backbone derived mainly from a polycarboxylate and a poly alcohol, e.g., a majority of the ester linkages in the backbone are derived from a polycarboxylate and a polyol, such as found in poly(ethylene adipate) glycol:

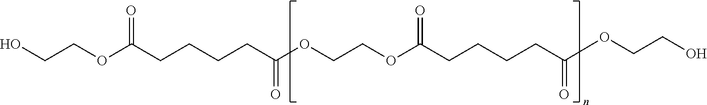

“Polylactone polyol” as used herein refers to a polyol having a backbone derived mainly from a hydroxycarboxylic acid or lactone, as opposed to being derived from a polycarboxylate and a polyol, as found in poly caprolactone:

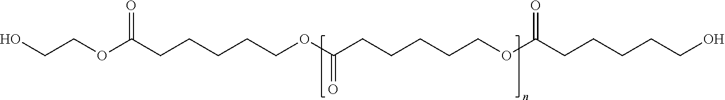

“Polycarbonate polyol” as used herein refers to a polyol having a backbone comprising mainly carbonate linkages, —O(CO)—O—, as opposed to carboxylate linkages, —O(CO)—R, wherein R is an organic radical bound to the carbonyl by a C—C bond.

“Co-polyester polyols”, as used herein refers to a polyol wherein a portion of the backbone is derived from a polycarboxylate and a poly alcohol as described above, and a portion of the backbone is derived from a hydroxyacid or lactone, or which also incorporates carbonate linkages.

For example, useful polyols may include polyesters of adipic acid or other dicarboxylic acids; polyethers of ethylene oxide, propylene oxide, 1,3-propanediol, tetrahydrofuran, etc.; polycaprolactone (PCL), polycarbonate, and copolymers and terpolymers formed from the above, and mixtures thereof. In various optional embodiments, the polyol comprises glycols or triols having molecular weights ranging, for example, from 60 to 400, e.g., from 80 to 300 or from 100 to 200, for example, such glycols or triols may include ethylene glycol, isomers of propylene glycol, isomers of butane diol, isomers of pentanediol, isomers of hexanediol, trimethylolpropane, pentaerythritol, diethylene glycol, triethylene glycol, dipropylene glycol, tripropylene glycol, etc., and mixtures thereof.

Often, the polyether polyol is a polyalkylene ether polyol represented by the general formula HO(RO)ₙH, wherein R is an alkylene radical and n is an integer large enough that the polyether polyol has a number average molecular weight of at least 250. These polyalkylene ether polyols are well-known components of polyurethane products and can be prepared by the polymerization of cyclic ethers such as alkylene oxides and glycols, dihydroxyethers, and the like by known methods. Representative polyols include polyethylene glycols, polypropylene glycols (PPG), copolymers from propylene oxide and ethylene oxide (PPG-EO glycol), poly(tetramethylene ether) glycol PTMEG or PTMG, and the like.

The polyester polyols are typically prepared by reaction of dibasic acids, e.g., adipic, glutaric, succinic, azelaic, sebacic, or phthalic acid or derivatives thereof, with diols such as ethylene glycol, 1,2-propylene glycol, 1,4-butylene glycol, 1,6-hexylene glycol, and alkylene ether polyols such as diethylene glycol, polyethylene glycol, polypropylene glycols, polytetramethylene ether glycol and the like. Polyols such as glycerol, trimethylol propane, pentaerthythritol, sorbitol, and the like may be used if chain branching or ultimate cross-linking is sought. Examples of polyester polyols include poly(adipate) glycol, poly(hexamethylene adipate) glycol, poly(ethylene adipate) glycol, poly(diethylene adipate) glycol, poly(ethylene/propylene adipate) glycol, poly(trimethylolpropane/hexamethylene adipate) glycol, poly(ethylene/butylene adipate) glycol, poly(butylene adipate) glycol, poly(hexamethylene/neopentyl adipate) glycol, poly(butylene/hexamethylene adipate) glycol (PBHAG), poly(neopentyl adipate) glycol, and the like including copolymers and terpolymers thereof.

Polylactone polyols include those made by polycondensation of, e.g., a caprolatone such as ε-caprolactone, and the like, often initiated by a small polyol such as ethylene glycol.

Hydrocarbon polyols can be prepared from ethylenically unsaturated monomers such ethylene, isobutylene, and 1,3-butadiene, e.g., polybutadiene polyols and the like.

Polycarbonate polyols can also be used in forming the prepolymers of the invention and can be prepared by reaction of glycols, e.g., 1,6-hexylene glycol and the like, with organic carbonates, e.g., diphenyl carbonate, diethyl carbonate, or ethylene carbonate and the like.

Co-polyester polyols of the invention include those wherein the backbone comprises polyester portions and portions comprising caprolactone or polycaprolatone.

In many embodiments of the invention, the polyol used in forming the prepolymer comprises a diol, and in some embodiments, the majority or all of the polyols used in to form the prepolymer are diols.

In many embodiments, paraphenylene diisocyanate (PPDI) is the only polyisocyanate employed in the present invention. In some embodiments other polyisocyanates, typically diisocyanates, may also be used be present in small amounts, e.g., less than 20% by weight of all isocyanates, generally less than 10, 5 or 2 wt % of all isocyanates, based on the total weight of all polyisocyanates present during reaction with the polyol, may be added along with PPDI. If present, the other isocyanate monomers may include toluidine diisocyanate (TODI), isophorone diisocyanate (IPDI), 4,4′-methylene bis (phenylisocyanate) (MDI), toluene-2,4-diisocyanate (2,4-TDI), toluene-2,6-diisocyanate (2,6-TDI), naphthalene-1,5-diisocyanate (NDI), diphenyl-4,4′-diisocyanate, dibenzyl-4,4′-diisocyanate, stilbene-4,4′-diisocyanate, benzophenone-4,4′diisocyanate, 1,3- and 1,4-xylene diisocyanates, 1,6-hexamethylene diisocyanate, 1,3-cyclohexyl diisocyanate, 1,4-cyclohexyl diisocyanate (CHDI), the three geometric isomers of 1,1′-methylene-bis(4-isocyanatocyclohexane) (abbreviated collectively as H₁₂ MDI), and mixtures thereof.

Various embodiments of the invention provide the prepolymer having less than 1, 0.5, 0.1 or 0.05 wt % free isocyanate monomer prepared according to the inventive process, and a polyurethane polymer prepared by reacting the prepolymer with a curative. In preparing the polyurethane polymer, a prepolymer prepared as described above is cured by reaction with a curative, or curing composition, comprising one or more curing agents according to any appropriate process known in the art.

Curing agents, also called coupling agents or cross-linking agents, are well known in the art, and include various diols, triols, tetrols, diamines or diamine derivatives and the like. Any curing agent providing the desired properties can be employed. Common curing agents include C₂₋₁₂ alkylene diols such as ethane diol, propane diol, butane diol, cyclohexane dimethanol and the like hydroquinone-bis-hydroxyalkyl ethers such as hydroquinone-bis-hydroxyethyl ether, diethylene glycol etc.; ether diols such as dipropylene glycol, dibutylene glycol, triethylene glycol and the like, and a variety of diamines including methylenedianiline (MDA), naphthalene-1,5-diamine, ortho, meta, and para-phenylene diamines, toluene-2,4-diamine, dichlorobenzidine, diphenylether-4,4′-diamine,4,4′-methylene-bis(3-chloroaniline) (MBCA), 4,4′-methylene-bis(3-chloro-2,6-diethylaniline) (MCDEA), diethyl toluene diamine (DETDA), tertiary butyl toluene diamine (TBTDA), dimethylthio-toluene diamine, trimethylene glycol di-p-amino-benzoate, 1,2-bis(2-aminophenylthio)ethane, and methylenedianiline-sodium chloride complexes. One or more than one curing agent may be used.

For example, in some embodiments the curing agent comprises a diol or other polyol, in some other embodiments the curing agent comprises a polyol, e.g., diamine, or a diamine sodium chloride coordination complex. In some embodiments, the curative comprises a mixture of polyols, polyamines, or polyols and polyamines, e.g., a C₂₋₆ diol, cyclohexane dimethanol and/or hydroquinone-bis-hydroxyethyl ether. In certain embodiments, the curing agent comprises 1,4-butane diol and/or hydroquinone-bis-hydroxyethyl ether, for example, 1,4-butanediol. The curing agent may also comprise alkylene polyols, polyether polyols such as PTMG, polyester polyols, polycaprolactone polyols or polycarbonate polyols, such as those described above as starting materials for the prepolymers, typically as a blend with a diol or triol.

The molar ratio of prepolymer to curing composition, for example, may be in the range of from 0.5:1 to 1.5:1, e.g., from 0.7:1 to 1.2:1 or from 1.1:1 to 0.95:1. The amount of curing composition to be added may also be determined by methods well known to one of ordinary skill in the art and will depend on the desired characteristics of the resin being formed. In some embodiments catalysts may be used in conjunction with the curative.

Many of the polyols, solvents and curing agents useful in the present invention are commercially available or prepared according to known methods, as are PPDI and other polyisocyanates that may be employed. Free NCO content can be determined by a procedure similar to that described in ASTM D1638-70, but employing tetrahydrofuran as the solvent. Unreacted PPDI monomer content of prepolymers can determined by, e.g., HPLC.

Surprisingly it has been found that the process described herein, comprising co-distilling PPDI and solvent to prepare a solution of PPDI in the solvent, mixing the solution of PPDI obtained from the co-distillation with one or more polyols to form a prepolymer, and then removing unreacted PPDI by distillation in the presence of solvent provides a PPDI prepolymer with a low level of free PPDI monomer that also has better properties and which has lower color than a prepolymer prepared according to U.S. Pat. No. 5,703,193.

A single solvent may be used throughout the process, and as mentioned above, in some embodiments the process may be carried out in the absence or near absence of a solvent with a boiling point higher than that of PPDI. One advantage of these embodiments is that they avoid certain processing challenges associated with the preparation of low free PPDI prepolymers, such as with the use of a combination of low and high boiling solvents as in U.S. Pat. No. 5,703,193. For example, a single solvent can be used so that the challenges of recycling a solvent mixture are avoided. Also, a solvent with a higher boiling point than PPDI is often difficult to remove from the prepolymer and requires the use of higher temperatures, which can cause degradation of the prepolymer. The higher temperatures can also cause degradation of the residual PPDI creating further impurities and often higher amounts of unwanted color.

Thus, some embodiments of the present invention avoid the use of solvents with a boiling point at 760 torr of greater than 260° C. and in some embodiments the inert organic solvent or solvents employed consist essentially of solvents with a boiling point at 760 torr of less than 260° C., i.e., any amount of the higher boiling solvent is trivial, e.g., less than 5, 2, or 1 wt %, and its presence has no noticeable effect in the process.

### EXAMPLES

### Example I

PPDI prepolymer prepared by reacting PPDI and PTMEG 1000, and then removing unreacted PPDI from the prepolymer product composition by distillation in the presence of an inert organic solvent with a boiling point lower than that of PPDI. The PPDI was not distilled in the presence of an inert organic solvent prior to reaction with the polyol.

To a mixture comprising 800 parts PPDI (bp 260° C.) and 3200 parts of dimethyl adipate (bp 225-230°) in a batch reaction flask equipped with nitrogen sweep, agitator, thermometer, heating mantle, and a vacuum source, was added 952 parts PTMEG 1000 (952 mw). The molar ratio of PPDI to PTMEG (hence the equivalent ratio of NCO groups to OH groups) was 5:1. The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and dimethyl adipate to yield a stripped prepolymer having 5.6% available isocyanate groups, and containing less than 0.1 wt % free PPDI, and a maximum of 0.1 wt % of dimethyl adipate.

### Example II

PPDI prepolymer prepared by first co-distilling PPDI and an inert organic solvent to obtain a solution of PPDI and the solvent, reacting the PPDI solution prepared in the co-distilling step with PTMEG 1000, and then removing unreacted PPDI from the prepolymer product composition by distillation in the presence of an inert organic solvent with a boiling point lower than that of PPDI.

A distilled PPDI solution was prepared by mixing 1000 parts PPDI with 4000 parts of dimethyl adipate to prepare a solution which was passed through a wiped film evaporator. 4000 parts of the distilled PPDI solution was charged to a batch reaction flask equipped with nitrogen sweep, agitator, thermometer, heating mantle, and a vacuum source and then 952 parts PTMEG 1000 (952 mw) was added (molar ratio of PPDI to PTMEG was 5:1 as in Example I). The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and dimethyl adipate to yield a stripped prepolymer having 5.8% available isocyanate groups, and containing less than 0.1 wt % free PPDI, and a maximum of 0.1 wt % of dimethyl adipate.

### Example III

PPDI prepolymer prepared by reacting PPDI and PTMEG 1000, and then removing unreacted PPDI from the prepolymer product composition by distillation in the presence of an inert organic solvent with a boiling point lower than that of PPDI and an inert organic solvent with a boiling point higher than that of PPDI. The PPDI was not distilled in the presence of an inert organic solvent prior to reaction with the polyol.

To a mixture comprising 800 parts PPDI (bp 260° C.), 1600 parts of dimethyl adipate and 1600 parts of dimethyl phthalate (bp 282° C.), in a batch reaction flask equipped with nitrogen sweep, agitator, thermometer, heating mantle, and a vacuum source, was added 952 parts PTMEG 1000 (952 MW). The molar ratio of PPDI to PTMEG was 5:1 as in Example I. The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and dimethyl adipate to yield a stripped prepolymer having 5.4% available isocyanate groups, and containing less than 0.1% free PPDI, and 0.11% DMA/DMP.

### Example IV

PPDI prepolymer prepared by first co-distilling PPDI and an inert organic solvent to obtain a solution of PPDI and the solvent, reacting the PPDI solution prepared in the co-distilling step with PTMEG 1000 and PTMEG 650, and then removing unreacted PPDI from the prepolymer product composition by distillation in the presence of an inert organic solvent with a boiling point lower than that of PPDI.

A distilled PPDI solution was prepared by mixing 1000 parts PPDI with 4000 parts of dimethyl adipate to prepare a solution which was passed through a wiped film evaporator. 4000 parts of the distilled PPDI solution was charged to a batch reaction flask equipped with nitrogen sweep, agitator, thermometer, heating mantle, and a vacuum source and then 850 parts PTMEG 1000/650 blend (700 mw) was added (molar ratio of PPDI to PTMEG was 4:1). The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and dimethyl adipate to yield a stripped prepolymer having 7.8% available isocyanate groups, and containing less than 0.1 wt % free PPDI, and a maximum of 0.1 wt % of dimethyl adipate.

### Example V

PPDI prepolymer prepared by reacting PPDI and PTMEG 1000 and PTMEG 650, and then removing unreacted PPDI from the prepolymer product composition by distillation in the presence of mixing of an inert organic solvent with a boiling point lower than that of PPDI and an inert organic solvent with a boiling point higher than that of PPDI. The PPDI was not distilled in the presence of an inert organic solvent prior to reaction with the polyol.

To a mixture comprising 800 parts PPDI (bp 260° C.), 2200 parts of dimethyl adipate and 1100 parts of dimethyl phthalate (bp 282° C.), in a batch reaction flask equipped with nitrogen sweep, agitator, thermometer, heating mantle, and a vacuum source, was added 680 parts PTMEG 1000/PTMEG 650 blend (700 MW). The molar ratio of PPDI to PTMEG was 4:1. The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and inert solvent to yield a stripped prepolymer having 7.2% available isocyanate groups, and containing less than 0.1% free PPDI, and 0.2% dimethyl adipate/dimethyl phthalate.

### Example VI

PPDI prepolymer prepared by first co-distilling PPDI and an inert organic solvent to obtain a solution of PPDI and the solvent, reacting the PPDI solution prepared in the co-distilling step with polycaprolactone, and then removing unreacted PPDI from the prepolymer product composition by distillation in the presence of an inert organic solvent with a boiling point lower than that of PPDI.

A distilled PPDI solution was prepared by mixing 1000 parts PPDI with 4000 parts of dimethyl adipate to prepare a solution which was passed through a wiped film evaporator. 4000 parts of the distilled PPDI solution was charged to a batch reaction flask equipped with nitrogen sweep, agitator, thermometer, heating mantle, and a vacuum source and then 3000 parts Polycaprolactone 2000 and Polycaprolactone 1000 blend (900 MW) was added (molar ratio of PPDI to Polyol was 3:1). The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and dimethyl adipate to yield a stripped prepolymer having 4.0% available isocyanate groups, and containing less than 0.1 wt % free PPDI, and a maximum of 0.1 wt % of dimethyl adipate.

### Example VII

PPDI prepolymer prepared by reacting PPDI and Polycaprolactone, and then removing unreacted PPDI from the prepolymer product composition by distillation in the presence of mixing of an inert organic solvent with a boiling point lower than that of PPDI and an inert organic solvent with a boiling point higher than that of PPDI. The PPDI was not distilled in the presence of an inert organic solvent prior to reaction with the polyol.

To a mixture comprising 800 parts PPDI (bp 260° C.), 2200 parts of dimethyl adipate and 1100 parts of dimethyl phthalate (bp 282° C.), in a batch reaction flask equipped with nitrogen sweep, agitator, thermometer, heating mantle, and a vacuum source, was added 3000 parts Polycaprolactone 2000 and Polycaprolactone 1000 blend (900 MW). The molar ratio of PPDI to Polyol was 3:1. The reaction mixture was heated for 6 hours at 80° C.; a vacuum of 1-10 torr was applied during the final hour of heating to remove entrained gases. The crude reaction mixture was then processed through a wiped film evaporator to remove unreacted PPDI and inert solvent to yield a stripped prepolymer having 3.7% available isocyanate groups, and containing less than 0.1% free PPDI, and 0.15% dimethyl adipate/dimethyl phthalate.

The properties of the prepolymers having free PPDI <0.1% from Examples I through VII are shown in Table 1, and properties of the polyurethane polymers prepared by curing the prepolymers from Examples I through VII with 1,4-butane diol are shown in Table 2. Low color prepolymers form examples II, IV and VI are featured with clear appearance, easier process (lower viscosity), and which provide polymers with higher tear strength.

TABLE 1
Prepolymer Properties

| | Example | | | | | | |
|---|---|---|---|---|---|---|---|
| | I | II | III | IV | V | VI | VII |
| Polyol | Ether | Ether | Ether | Ether B | Ether B | Lactone | Lactone |
| % NCO | 5.6 | 5.8 | 5.4 | 7.8 | 7.2 | 4.0 | 3.7 |
| Viscosity | 2 | 1.5 | 3 | 1 | 2 | 4 | 4.5 |
| 100 C., poise | | | | | | | |
| % PPDI | <0.1 | <0.1 | <0.1 | <0.1 | <0.1 | <0.1 | <0.1 |
| % DMA | <0.1 | <0.1 | <0.1 | <0.1 | <0.1 | <0.1 | <0.05 |
| % DMP | NA | NA | 0.11 | NA | 0.2 | NA | 0.1 |
| Clarity | Cloudy | Clear | Cloudy | Clear | Cloudy | Clear | Cloudy |
| Color | yellow | colorless | dark | colorless | dark | colorless | dark |
| | | | yellow | | Yellow | | yellow |

Ether—PTMEG 1000
Ether B—Blend of PTMEG 1000/PTMEG 650
Lactone—Polycaprolactone
DMA—dimethyl adipate
DMP—dimethyl phthalate.

TABLE 2
Polyurethane Properties

| | Prepolymer Example | | | | | | |
|---|---|---|---|---|---|---|---|
| | I | II | III | IV | V | VI | VII |
| Hardness | 95A | 97A/44D | 94A | 60D | 60D | 95A | 95A |
| Dropped Ball | 57 | 59 | 55 | 50 | — | 62 | 63 |
| Rebound, % | | | | | | | |
| Split Tear pli | 130 | 150 | 130 | 140 | 130 | 160 | 140 |
| (ASTM D-470) | | | | | | | |

Comparative Examples A and B provide conventional PPDI prepolymers prepared without using solvent and without removing excess PPDI from the prepolymer.

### Comp Example A

PPDI prepolymer prepared by reacting the PPDI with PTMG, without using inert organic solvent. After reaction, unreacted PPDI was not removed from the prepolymer.

700 parts of PPDI was charged to 2000 parts PTMEG 1000 (molar ratio of PPDI to PTMEG was 2.2:1) in a reaction flask equipped with nitrogen sweep, agitator, thermometer, heating mantle, and a vacuum source. The reaction mixture was heated for 4 hours at 80° C.; a vacuum of 1-10 torr was applied during the final hour of heating to remove entrained gases. The final prepolymer has 6.7% available isocyanate groups, and contains 1.5 wt % free PPDI.

### Comp Example B

PPDI prepolymer prepared by reacting the PPDI with Polycaprolactone, without using inert organic solvent. After reaction, unreacted PPDI was not removed from the prepolymer.

600 parts of PPDI was charged to 3000 parts Polycaprolactone 2000 (molar ratio of PPDI to Polycaprolactone was 2.5:1) in a reaction flask equipped with nitrogen sweep, agitator, thermometer, heating mantle, and a vacuum source. The reaction mixture was heated for 4 hours at 80° C.; a vacuum of 1-10 torr was applied during the final hour of heating to remove entrained gases. The final prepolymer has 4.4% available isocyanate groups, and contains 3 wt % free PPDI.

The properties of these conventional prepolymers are compared with corresponding low free monomer prepolymers of the invention in Table 3.

TABLE 3
Comparison of Prepolymers of the Invention
with those of Comp Examples A and B

| | Example II | Comp A | Example VI | Comp B |
|---|---|---|---|---|
| Polyol | PTMEG | PTMEG | Polycaprolac- | Polycaprolac- |
| | 1000 | 1000 | tone | tone |
| % NCO | 5.8 | 6.7 | 4.0 | 4.4 |
| Clarity | Clear | Cloudy | Clear | Cloudy |
| Color | colorless | Dark yellow | colorless | Dark yellow |
| Viscosity, | 1.5 | — | 4 | 7 |
| 100 C., | | | | |
| poise | | | | |
| % PPDI | <0.1 | 1.5 | <0.1 | 3 |

What is claimed is:

1. A process for preparing a prepolymer containing less than 1 wt % free polyisocyanate monomer based on the total weight of the prepolymer from a mixture comprising PPDI and one or more polyols, which process comprises
i) subjecting a mixture comprising, based on the total weight of the mixture, from 5 to 85 wt % polyisocyanate monomer and from 15 to 95 wt % inert organic solvent, wherein 80 to 100% by weight of all polyisocyanate monomer present in the mixture is PPDI, to distillation under conditions wherein PPDI and the inert organic solvent co-distill, and collecting a distillate forming a solution comprising PPDI and inert organic solvent;
ii) preparing a reaction mixture comprising the solution collected as distillate in i) with one or more polyols, which reaction mixture comprises a stoichiometric ratio of isocyanate groups to hydroxyl groups of from 1.1 to 1 to 15:1, under conditions wherein PPDI and the one or more polyol react forming a prepolymer product mixture comprising prepolymer, unreacted PPDI and inert organic solvent, and
iii) subjecting the prepolymer product mixture to distillation conditions to remove unreacted PPDI and inert organic solvent to yield a prepolymer containing less than 1 wt % free polyisocyanate monomer.

2. The process according to claim 1 wherein 90 to 100% by weight of all polyisocyanate monomer present in the mixture subjected to distillation in i), the reaction mixture and prepolymer product mixture in ii) and the prepolymer product mixture in iii) is PPDI.

3. The process according to claim 1 wherein 98 to 100 wt % of the polyisocyanate monomer present in the mixture subjected to distillation in i) is PPDI.

4. The process according to claim 1, wherein the inert organic solvent present in the mixture subjected to distillation and collected as distillate in i), present in the reaction mixture and prepolymer product mixture of ii), and in the prepolymer product mixture subjected to distillation in iii) comprises one or more solvent having a boiling point at 760 torr of from 100° C. to 259° C.

5. The process according to claim 1, wherein the inert organic solvent present in the mixture subjected to distillation and collected as distillate in i), present in the reaction mixture and prepolymer product mixture of ii), and in the prepolymer product mixture subjected to distillation in iii) comprises one or more solvent having a boiling point at 760 torr of greater than 260° C.

6. The process according to claim 1, wherein 90 to 100% by weight of all inert organic solvent present in the mixture subjected to distillation and collected as distillate in i), present in the reaction mixture and prepolymer product mixture of ii), and in the prepolymer product mixture subjected to distillation in iii) has a boiling point at 760 torr of from 100° C. to 259° C.

7. The process according to claim 1, wherein the mixture subjected to distillation in i) comprises 10 to 60 wt % polyisocyanate monomer, and from 40 to 90 wt % inert organic solvent.

8. The process according to claim 1 wherein 98 to 100% by weight of all polyisocyanate monomer present in the mixture subjected to distillation in i), the reaction mixture and prepolymer product mixture in ii) and the prepolymer product mixture in iii) is PPDI.

9. The process according to claim 1, wherein the distillation of i) and/or iii) is carried out under reduced pressure.

10. The process according to claim 1, wherein the distillation of i) and/or iii) comprises distillation conducted in a falling film evaporator, wiped film evaporator and/or short-path distiller.

11. The process according to claim 9, wherein the distillation of i) and/or iii) comprises distillation conducted in a falling film evaporator, wiped film evaporator and/or short-path distiller.

12. The process according claim 1, wherein the inert organic solvent present in the mixture and distillate of i), in the reaction mixture and prepolymer product mixture of ii) and in the prepolymer product mixture subjected to distillation in iii) comprises one or more compound selected from the group consisting of 1,2,3-trichlorobenzene, 1,2,4-trichlorobenzene, o-dichlorobenzene, m-dichlorobenzene, p-dichlorobenzene, dimethylglutarate, dimethyl adipate, diethyl adipate, dimethyl succinate, gamma-butyrolactone, delta-Valero lactone, propylene carbonate, N-methylpyrollidone and dimethyl phthalate.

13. The process according to claim 12 wherein the organic solvent present in the mixture and distillate of i), the reaction mixture and prepolymer product mixture of ii) and the prepolymer product mixture subjected to distillation in iii) comprises one or more compound selected from the group consisting of 1,2,3-trichlorobenzene, 1,2,4-trichlorobenzene, o-dichlorobenzene, m-dichlorobenzene, p-dichlorobenzene, dimethylglutarate, dimethyl adipate, diethyl adipate, dimethyl succinate, gamma-butyrolactone, delta-Valero lactone, propylene carbonate and N-methylpyrollidone, and wherein no phthalate is present.

14. The process according to claim 12 wherein the organic solvent present in the mixture and distillate of i), in the reaction mixture and prepolymer product mixture of ii) and in the prepolymer product mixture subjected to distillation in iii) comprises one or more of dimethylglutarate, dimethyl adipate, diethyl adipate, and dimethyl succinate.

15. The process according to claim 1, wherein the prepolymer obtained after iii) comprises less than 0.5 wt % free polyisocyanate monomer.

16. The process according to claim 1, wherein the prepolymer obtained comprises less than 0.1 wt % free polyisocyanate monomer.

17. A prepolymer obtained by the process according to claim 1.

18. A polyurethane prepared by reacting the prepolymer according to claim 17 with a curative comprising one or more compounds selected from the group consisting of diols, triols, tetrols, diamines and diamine derivatives.
